(19) United States
(12) Patent Application Publication
(10) Pub. No.: US 2018/0331623 A1
(43) Pub. Date: Nov. 15, 2018

(54) INPUT/OUTPUT CIRCUIT

(71) Applicant: Infineon Technologies AG, Neubiberg (DE)

(72) Inventors: Stefan Drapatz, Garmisch-Partenkirchen (DE); Hans Christoph Lehmann, Munich (DE)

(21) Appl. No.: 15/591,621

(22) Filed: May 10, 2017

(51) Int. Cl. H02M 3/158; H02M 1/08; H02M 1/32; H02H 9/04

(52) U.S. Cl. CPC H02M 3/158; H02H 9/045; H02M 1/32; H02M 1/08

(57) ABSTRACT

Devices and methods are provided which regulate a voltage supplied to an input/output circuit if a voltage at a pad exceeds a threshold.

### TECHNICAL FIELD

The present application relates to input/output circuits and to corresponding methods.

### BACKGROUND

Input/output circuits serve as part of an integrated circuit to interface between the outside world and internal circuit parts of the integrated circuit. For designing integrated circuit, such input/output circuits are provided as input/output (I/O) cells, which may be added to the circuit design. Input/output circuits may provide various functionalities like protection from electrostatic discharge (ESD protection) and in many cases voltage level conversion. In particular, in many chip designs an internal operating voltage of the chip may be lower than voltages of signals input to the chip and output from the chip. For example, in some chip designs an internal operating voltage may be about 1.2 Volts, whereas signals output by the chip or input to the chip may have a voltage up to 3.3 Volts, and the input/output circuits provide corresponding voltage conversion between the lower voltage on the chip and the higher voltage outside the chip. In other cases, the internal operating voltage may be equal to the voltages of the signal, in which case no level shifting is needed.

The voltage outside the chip is sometimes referred to as VDDP, pad voltage on pads of the chip serving to connect to the outside world.

In some cases, it may happen that a signal supplied to the chip has a higher voltage than this voltage VDDP. This may lead to damaging of the chip, in particular the I/O circuit. In particular, ESD protection circuits are usually designed only for short ESD pulses, and applying higher voltages over a longer time may even damage ESD protection of the input/output circuit.

### SUMMARY

According to an embodiment, a device is provided, comprising:

a pad,

an input/output circuit, and

a voltage regulator circuit coupled between the pad and the input/output circuit, wherein the voltage regulator circuit comprises a regulation loop configured to reduce a voltage at a node between the voltage regulator circuit and the input/output circuit if the voltage at the node exceeds a predefined threshold voltage.

According to another embodiment, a device is provided, comprising:

an input/output circuit,

a pad,

a transistor coupled between the pad and the input/output signal,

a control circuit coupled to a node between the transistor and the input/output circuit and to a reference voltage and configured to control the transistor depending on a difference between a voltage at the node and the reference voltage.

According to another embodiment, a method is provided, comprising:

providing a signal at an input/output pad, and

regulating a voltage at an input/output circuit coupled to the input/output pad depending on the voltage at the input/output circuit exceeding a predetermined threshold voltage.

The above summary is merely intended to provide a brief overview over some features of some embodiments and is not to be construed as limiting. In particular, other embodiments may include other features than the ones mentioned above.

### BRIEF DESCRIPTION OF THE DRAWINGS

FIG. 1 is a schematic diagram of an input/output circuit as an example basis for some embodiments.

FIGS. 2A and 2B are diagrams illustrating potential problems when a high voltage is applied to a pad of an input/output circuit.

FIG. 3 is a schematic diagram of an input/output circuit according to an embodiment.

FIG. 4 is a signal diagram illustrating some embodiments.

FIGS. 5-7 are circuit diagrams illustrating input/output circuits according to various embodiments.

FIG. 8 is a flow chart illustrating a method according to an embodiment.

### DETAILED DESCRIPTION

In the following, various embodiments will be described in detail referring to the attached drawings. These embodiments are given as examples only and are not to be construed as limiting in any way. For example, while embodiments may be described comprising a plurality of features or elements, this is not to be construed as limiting, and in other embodiments some of the features or elements may be omitted, and/or may be replaced by alternative features or elements. In addition to the features or elements explicitly described, further features or elements, for example features or elements conventionally provided in input/output (I/O) circuits may be used, for example conventional electrostatic discharge (ESD) protection circuitry.

Features or elements from different embodiments may be combined with each other to form further embodiments unless noted otherwise. Variations and modifications described with respect to one of the embodiments may also be applicable to other embodiments.

In the embodiments shown and described, any direct electrical connection or coupling between elements, i.e. connection or coupling without intervening elements, may be replaced by an indirect connection or coupling, i.e. a connection or coupling comprising one or more additional intervening elements, and vice versa, as long as the general purpose of the connection or coupling, for example to provide a certain kind of signal, a certain kind of information or a certain kind of control is essentially maintained. In other words, connections or couplings may be modified as long as the general purpose and function of the connection or coupling remains essentially unaltered.

Embodiments relate to I/O circuits, which may be for example provided as I/O cells in a design library for designing integrated circuits. The terms I/O circuit, I/O terminal or I/O pad relate to circuits, terminals or pads which are used to input signals to a circuit, output signals from a circuit or both. “Signals” related to I/O circuits, terminals or pads relate to signals carrying some kind of information, in particular modulated signals (for example digital signals which assume one of two values to encode a logic one or a logic zero or analog signals). In contrast, supply voltage terminals where in operation a basically constant or varying supply voltage is applied for supplying the circuit with power without conveying information are not regarded as I/O circuits, I/O terminals or pads in the context of the present application, although the I/O circuits may be supplied with power via such supply voltage terminals (but include at least one additional terminal or pad for outputting or inputting signals). A pad refers to a terminal of the I/O circuit which may then be connected to an outside terminal of a chip housing, e.g. a chip pin or other terminal, e.g. by bonding.

Some embodiments use a voltage regulator to regulate a voltage of a signal supplied to the I/O circuit at an I/O pad thereof. In particular, if the voltage at the I/O pad exceeds a predetermined threshold, the voltage regulation circuit may reduce this voltage to the predetermined threshold. The predetermined threshold may correspond to a higher supply voltage of the I/O circuit used for interfacing with the outside world, in contrast to a lower supply voltage used internally at a chip. Voltage regulation, as used herein, may refer to a regulation involving a regulation loop (closed loop) for regulating the voltage. Example regulation loops will be discussed further below.

Turning now to the Figures, FIG. 1 schematically illustrates an I/O circuit 10 which may form the basis of some embodiments described herein. I/O circuit 10 serves to interface between a domain using a higher voltage VDDP and a domain using a lower voltage VDD. In embodiments, VDD may be an internal positive supply voltage of a chip, for example 1.2 Volts, whereas VDDP may be a voltage associated with signals supplied to the chip via a pad 11 or output by the chip via pad 11, for example 3.3 Volts or 5.5 Volts. It should be noted that these numerical values serve only for illustrative examples and are not to be construed as limiting in any way. VSSP denotes a reference supply voltage, e.g. ground, 0V or a negative supply voltage.

In the embodiment of FIG. 1, I/O circuit 10 serves both for outputting signals via pad 11 and for receiving signals via pad 11. In other embodiments, I/O circuits may serve only for outputting signals or only for receiving signals.

For outputting signals, I/O circuit 10 receives an internal signal DQ via a terminal 12 from any internal circuitry of a chip (not shown in FIG. 1). Signal DQ may for example use VDD as logic one and VSSP as logic zero, in case of a digital signal, but is not limited thereto. Along an output path 14, signal DQ is level-shifted from VDD to VDDP and output at pad 11 as a signal P. Conventional level shifters may be used. Conversely, when a signal, for example a digital signal, having voltages up to VDDP, is received as signal P at pad 11, this signal in an input path 15 is level-shifted to an internal signal OUTI having a voltage up to VDD at a terminal 13 for further processing by internal circuitry of the chip using a level shifter. In addition to level shifters, I/O circuit 10 may include further conventional elements like buffers, ESD protection circuits or logic circuits. It should be noted that in other embodiments, VDDP may be equal to VDD, in which case one of the terminals supplying VDD or VDDP may be omitted and no level shifting is required.

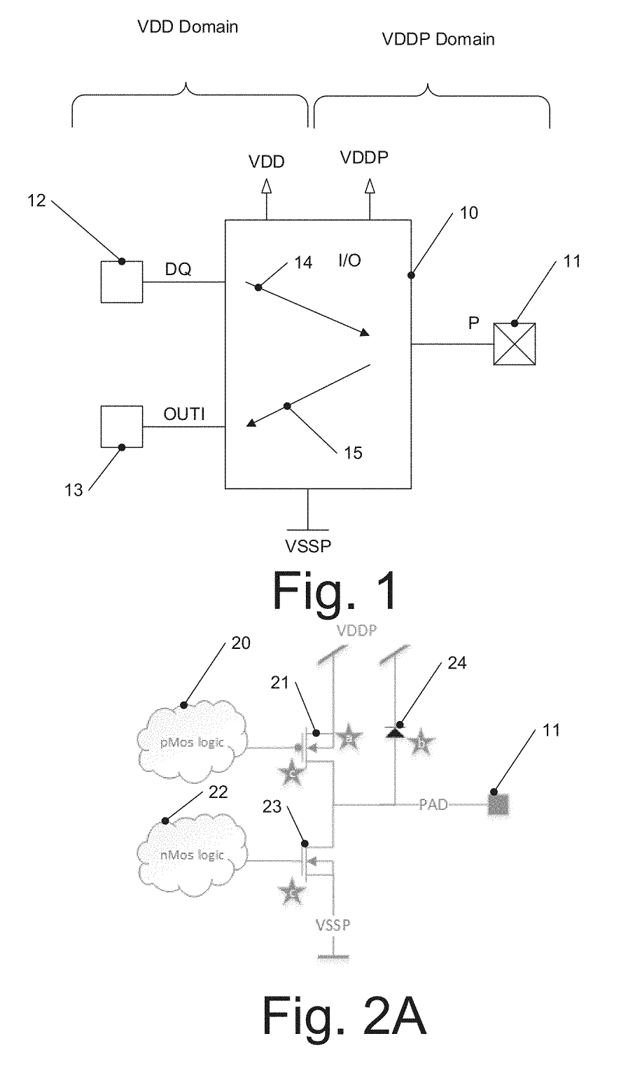

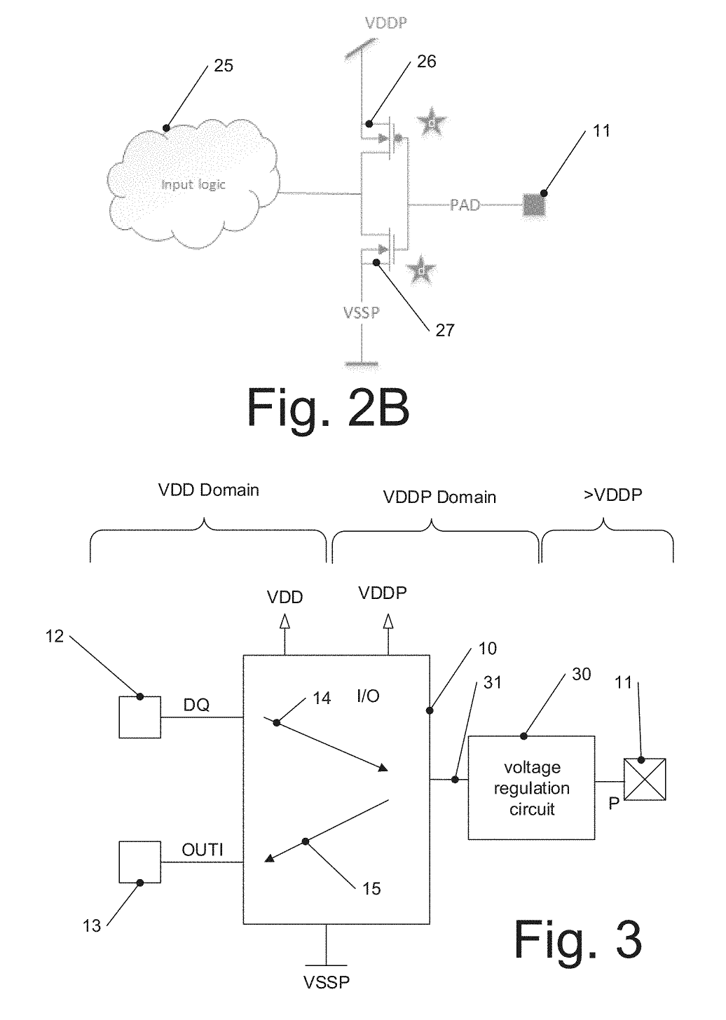

For correct operation, conventional I/O circuits require that a voltage at pad 11 in case of input signals does not exceed VDDP. When in conventional circuits a higher voltage than VDDP is applied to pad 11, this may lead to various problems, which will now be explained referring to FIGS. 2A and 2B.

FIG. 2A illustrates an output driver as may be used in I/O circuits according to various embodiments. The output driver comprises a PMOS transistor 21 and an NMOS transistor 23 coupled in series between VDDP and VSSP as shown. PMOS transistor 21 is controlled by a PMOS logic 20, and NMOS transistor 23 is controlled by an NMOS logic 22. A node between PMOS transistor 21 and NMOS transistor 23 is coupled to pad 11. A diode 24 serves as representing ESD protection. It is noted that in addition to diode 24 explicitly shown or as alternative thereto, any conventional ESD circuitry may be used.

When a voltage at pad 11 exceeds VDDP, the following problems may occurs:
As indicated by “a” in FIG. 2A, PMOS transistor 21 may be damaged when its bulk is at VDDP as shown, but its source (connected to pad 11) exceeds VDDP.
Diode 24 may be damaged if the voltage exceeding VDDP persists at pad 11 for times longer than typical ESD pulses, as indicated by “b”. In particular, when the voltage at pad 11 exceeds VDDP, diode 24 may become conducting to carry large currents. If these large currents continue over longer periods of times, diode 24 may be damaged.
Furthermore, as indicated by “c”, PMOS 21 and NMOS 23 may also be damaged if the maximum allowed drain source voltage of the transistor design of transistors 21, 23 does not tolerate corresponding voltages at pad 11.

FIG. 2B illustrates an input driver usable in some embodiments of an I/O circuit. The input driver of FIG. 2B comprises a PMOS transistor 26 and an NMOS transistor 27 coupled between VDDP and VSSP as shown. Gate terminals of transistors 26, 27 are coupled to pad 11 and therefore transistors 26, 27 are driven by a signal at pad 11. A node between transistors 26, 27 serves as an output node of the driver and is coupled to an input logic 25, which may further process the signal, in particular level-shift the signal to VDD. In case the voltage at pad 11 exceeds VDDP, as indicated by “d”, transistors 26, 27 may be damaged if the allowed gate source voltage of transistors 26, 27 does not tolerate the voltage applied at pad 11.

In embodiments, which will be discussed now in greater detail with reference to FIGS. 3 to 7, a voltage regulation circuit is provided to reduce voltages at pad 11 exceeding VDDP in order to prevent or mitigate at least some of the problems discussed above with reference to FIGS. 2A and 2B. In embodiments, this voltage regulation concerns signals applied at pad 11 from the outside (i.e. input signals) and does not affect signals output by the I/O circuit, which may have a voltage level VDDP based on operation of an output driver of the I/O circuit.

The description of the embodiments of FIGS. 3 to 7 is at least in part based on the I/O circuit already discussed with reference to FIG. 1, and corresponding elements bear the same reference numerals and will not be described repeatedly in detail.

In the embodiment of FIG. 3, a voltage regulation circuit 30 is provided between pad 11 and I/O circuit 10. Voltage regulation circuit 30 reduces a voltage supplied to I/O circuit 10 in case a voltage at pad 11 exceeds a predefined threshold, for example exceeds VDDP. Voltage regulation circuit 30 may include a regulation loop which regulates the voltage based on a voltage at a node 31 between voltage regulation circuit 30 and I/O circuit 10.

It should be noted that as voltage regulation circuit 30 is coupled between pad 11 and I/O circuit 10 in the embodiment of FIG. 3, no modification to I/O circuit 10 is necessary, and any conventional I/O circuit 10 may be used, for example standard I/O cells from a cell library. In other embodiments, voltage regulation circuit 30 may be integrated in I/O circuit 10.

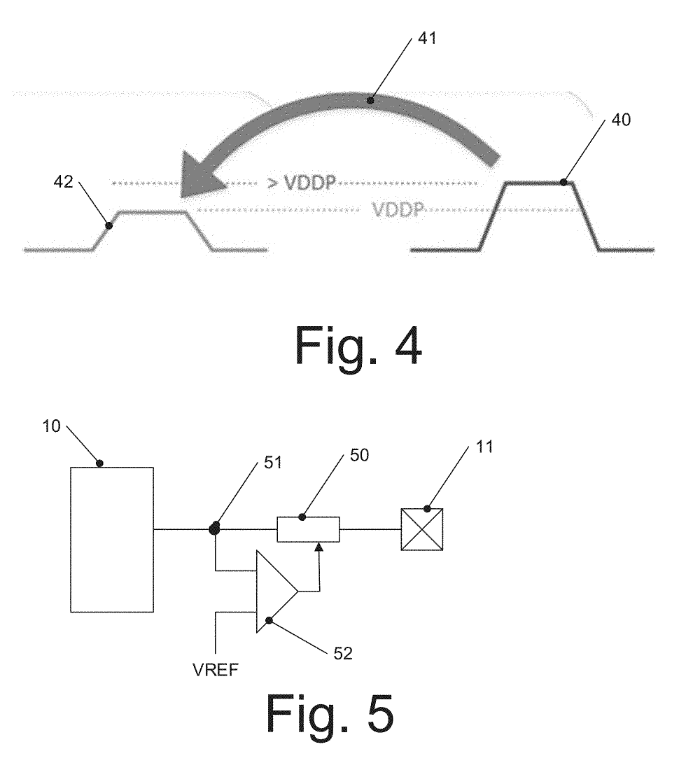

FIG. 4 illustrates an example effect of voltage regulation circuit 30 of FIG. 3. FIG. 4 illustrates some example signal waveforms, which are not to be construed as limiting.

In the illustrative example of FIG. 4, it is assumed that a signal waveform 40, for example a digital signal, is applied to pad 11 of FIG. 3 which during some time (for example when signal 40 is at logic 1 or high) exceeds VDDP, as indicated by a dotted line>VDDP in FIG. 4. As illustrated by an arrow 41, voltage regulation circuit 30 reduces the voltage of signal 40, where it exceeds VDDP, to be at VDDP, resulting in a signal 42. Instead of reducing to VDDP, the voltage may also be reduced to another predefined voltage.

It should be noted that in the embodiment illustrated by FIG. 4, signal 40 remains essentially unchanged by the voltage regulation where it does not exceed VDDP. “Essentially unchanged” in this respect means that parasitic filtering effects may occur due to parasitic inductances or capacitances of voltage regulation circuit 30. In particular, signal transitions between high and low are essentially preserved in the signal by the operation of voltage regulation circuit 40.

FIG. 5 illustrates a schematic circuit diagram of a voltage regulation circuit according to an embodiment coupled between pad 11 and I/O circuit 10.

The voltage regulation circuit of FIG. 5 comprises a variable component 50 having a variable electrical property, for example a variable impedance like a variable resistance. Examples for variable component 50 comprise transistors, the electrical properties of which may be controlled by supplying varying gate voltages or base currents, or variable resistors. Furthermore, the voltage regulation circuit of FIG. 5 comprises a comparator comparing a voltage at a node 51 between variable component 50 and I/O circuit 10 with a reference voltage VREF. Node 51 may correspond to node 31 of FIG. 3. Reference voltage VREF may be VDDP, but is not limited thereto and may also be another reference voltage like a bandgap voltage. In other examples, the reference voltage VREF may be defined by a break-through voltage of a diode like a Zener diode.

If the voltage at node 51 exceeds VREF, comparator 52 controls variable component 50 to reduce the voltage at node 51. In this way, the voltage at node 51 may be regulated to VREF. On the other hand, if the voltage at node 51 is below VREF, comparator 52 may control variable component 50 to provide a low resistance such that the voltage at node 51 essentially corresponds to the voltage at pad 11. The circuit of FIG. 5 illustrates a simple example of a regulation loop usable in voltage regulators in some embodiments.

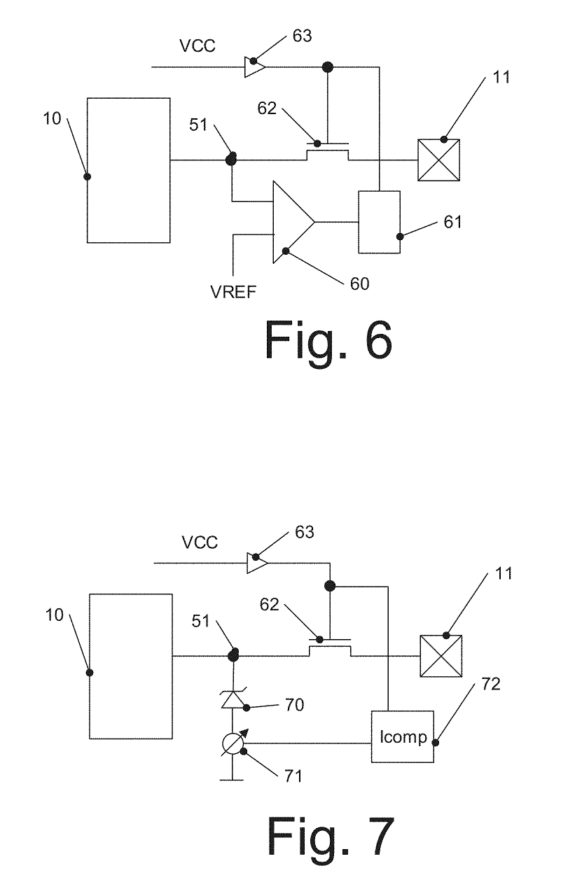

FIG. 6 illustrates an I/O circuit according to a further embodiment. In the embodiment of FIG. 6, an NMOS transistor 62 is provided between pad 11 and I/O circuit 10. NMOS transistor 62 depending on a voltage at its gate provides a variable resistance and is a non-limiting example for variable component 50 of FIG. 5. Instead of an NMOS transistor, for example a PMOS transistor, another kind of field effect transistor like DMOS transistors (double diffused metal oxide semiconductor transistors) or bipolar transistors like NPN transistors or PNP transistors or also insulated gate bipolar transistors (IGBTs) may be used.

In the embodiments of FIG. 6, a gate terminal of NMOS transistor 62 is biased by a voltage VCC via a buffer 63. Voltage VCC in the embodiment of FIG. 6 is a voltage higher than VDDP. Voltage VCC may be supplied externally or may also be generated internally based on VDDP or VDD using for example a charge pump. Buffer 63 may provide an ohmic resistance and/or may limit current flow.

A voltage at node 51 between NMOS transistor 62 and I/O circuit 10 is provided to a first input of a comparator or differential amplifier 60. A second input of comparator 60 is provided with reference voltage VREF. Instead of a comparator, also an amplifier may be used which outputs a signal depending on a difference between the voltage at node 51 and reference voltage VREF. Comparator 60 controls a circuit 61, which, in response to the signal from comparator 60, pulls a voltage at the gate terminal of transistor 62 towards a lower voltage (for example towards VSSP) if the voltage at node 51 exceeds VREF. For example, circuit 61 may comprise a further transistor which couples the gate terminal of NMOS transistor 62 with VSSP controlled by the output signal of comparator 60, which in this case may control a gate terminal or base terminal of this further transistor. When the gate terminal of transistor 62 is drawn toward VSSP or another low voltage (ground, negative voltage etc.), transistor 62 at least partially opens (i.e. increases its resistance), thus lowering the voltage at node 51. In other embodiments, other components may be used instead of or in addition to such a transistor to implement circuit 61, for example a current mirror and/or a current source. In this way, voltages exceeding VREF are regulated to VREF. As explained with reference to FIG. 5, VREF may be equal to VDDP, although this need not be the case.

FIG. 7 illustrates an I/O circuit according to a further embodiment. The embodiment of FIG. 7 is a modification of the embodiment of FIG. 6, and elements already described with reference to FIG. 6, in particular NMOS transistor 62 and buffer 63 via which a gate of NMOS transistor 62 is supplied with a voltage VCC will not be described again in detail. In FIG. 7, instead of comparator 60 and circuit 61, a Zener diode 70 is coupled between node 51 and ground. If a voltage at node 51 exceeds the breakthrough voltage of Zener diode 70, which in this case serves as a predefined reference voltage, Zener diode 70 partially becomes conducting. This current is measured by an Amperemeter (current measurement device) 71. A comparator 72 compares the measured current to a threshold (e.g. 0 or near 0), and, if the current exceeds the threshold (e.g. a current above leakage currents flows), draws the gate terminal of transistor 62 towards lower voltages and therefore increases a resistance of transistor 62, similar to what has been described for circuit 61 of FIG. 6. Also in this case, the voltage at node 51 is regulated accordingly.

As mentioned, the I/O circuits discussed may be part of an integrated circuit design and may be implemented together with other circuits of the integrated circuit on a single chip.

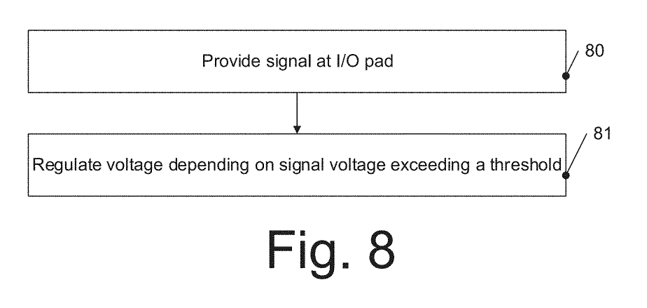

FIG. 8 is a flow chart illustrating a method according to an embodiment. The method of FIG. 8 may be implemented using the I/O circuits discussed previously, but may also be implemented independently therefrom. Nevertheless, for ease of illustration, the method of FIG. 8 will be discussed referring to the previously discussed I/O circuits.

At 80, the method of FIG. 8 comprises providing a signal at an I/O pad (for example I/O pad 11) of a chip. The signal may be a digital signal, but is not limited thereto and may also be an analog signal.

At 81, the method comprises regulating a voltage provided to an I/O circuit from the I/O pad depending on the voltage of the signal exceeding a threshold, for example a supply voltage VDDP as discussed. Regulating the voltage may comprise regulating the voltage to VDDP if the voltage exceeds VDDP. Instead of VDDP, another reference voltage may be used as threshold.

Some non-limiting embodiments are provided according to the following examples:

### EXAMPLE 1

A device, comprising:

a pad,

an input/output circuit, and

a voltage regulator circuit coupled between the pad and the input/output circuit, wherein the voltage regulator circuit comprises a regulation loop configured to reduce a voltage at a node between the voltage regulator circuit and the input/output circuit if the voltage at the node exceeds a predefined threshold voltage.

### EXAMPLE 2

The device of example 1, wherein the input/output circuit comprises a first voltage supply terminal for receiving a first positive voltage, a second supply voltage terminal to receive a second positive supply voltage and a third voltage supply terminal for receiving a referencesupply voltage, wherein the first supply voltage is higher than the second supply voltage.

### EXAMPLE 3

The device of example 2, wherein the input/output circuit comprises at least one level shifter to convert signals between a domain of the first supply voltage and a domain of the second supply voltage.

### EXAMPLE 4

The device of any one of examples 1-3, wherein the voltage regulation loop comprises a variable component having a varying electrical property arranged between the pad and the input/output circuit, and a control circuit controlling the variable component based on the voltage at the node and the predefined threshold voltage.

### EXAMPLE 5

The device of example 4, wherein the variable electrical property comprises a variable resistance.

### EXAMPLE 6

The device of example 4 or 5, wherein the variable component comprises a transistor.

### EXAMPLE 7

A device of example 6, wherein the transistor comprises an MOS metal oxide semiconductor field effect transistor, wherein a gate terminal of the transistor is coupled to a supply voltage higher than supply voltages supplying the input/output circuit.

### EXAMPLE 8

The device of any one of examples 4-7, wherein the control circuit comprises a comparator, wherein a first input of the comparator is coupled to the node and a second input of the comparator is coupled to the predefined threshold voltage.

### EXAMPLE 9

The device of any one of examples claim 4-8, wherein the control circuit comprises a Zener diode, the predefined threshold voltage being a breakthrough voltage of the Zener diode.

### EXAMPLE 10

The device of any one of examples 4-9, wherein the input/output circuit is supplied by a relatively higher positive voltage and a relatively lower positive voltage, wherein the predefined threshold voltage corresponds to the relatively higher supply voltage.

### EXAMPLE 11

The device of any one of examples 1-10, wherein the input/output circuit is configured to at least one of receiving information carrying signals from the pad or outputting information carrying signals to the pad.

### EXAMPLE 12

A device, comprising:

an input/output circuit,

a pad,

a transistor coupled between the pad and the input/output signal,

a control circuit coupled to a node between the transistor and the input/output circuit and to a reference voltage and configured to control the transistor depending on a difference between a voltage at the node and the reference voltage.

### EXAMPLE 13

The device of example 12, wherein the control circuit comprises a comparator.

### EXAMPLE 14

The device of example 12 or 13,

wherein the transistor comprises an NMOS transistor,

wherein a gate terminal of the NMOS transistor is coupled to a supply voltage higher than supply voltages supplying the input/output circuit,

wherein the control circuit is configured to draw the gate terminal of the transistor towards a lower voltage if the voltage at the node exceeds the reference voltage.

### EXAMPLE 15

A method, comprising:

providing a signal at an input/output pad, and

regulating a voltage at an input/output circuit coupled to the input/output pad depending on the voltage at the input/output circuit exceeding a predetermined threshold voltage.

### EXAMPLE 16

The method of example 15, wherein regulating the voltage comprises regulating the voltage using a regulation loop.

### EXAMPLE 17

The method of example 15 or 16, wherein the method further comprises supplying the input/output circuit with a first supply voltage defining a first voltage domain and a second supply voltage lower than the first supply voltage defining a second voltage domain, wherein the threshold voltage essentially corresponds to the first supply voltage.

In view of the many variations and modifications discussed above, it is evident that the embodiments are not to be construed as limiting the scope of the present application in any way.

1. A device comprising:
a pad;
an input/output circuit, and
a voltage regulator circuit coupled between the pad and the input/output circuit and
a node between the voltage regulator circuit and the input/output circuit,
wherein the voltage regulator circuit comprises a regulation loop configured to reduce a voltage at the node to a first predefined threshold voltage if the voltage at the node exceeds a second predefined threshold voltage.

2. The device of claim 1, wherein the input/output circuit comprises:
a first voltage supply terminal for receiving a first positive voltage;
a second supply voltage terminal to receive a second positive supply voltage; and
a third voltage supply terminal for receiving a reference supply voltage,
wherein the first supply voltage is higher than the second supply voltage.

3. The device of claim 2, wherein the input/output circuit comprises at least one level shifter to convert signals between a domain of the first supply voltage and a domain of the second supply voltage.

4. The device of claim 1, wherein the voltage regulation loop comprises:
a variable component having a varying electrical property arranged between the pad and the input/output circuit, and
a control circuit controlling the variable component based on the voltage at the node and the second predefined threshold voltage.

5. The device of claim 4, wherein the variable electrical property comprises a variable resistance.

6. The device of claim 4, wherein the variable component comprises a transistor.

7. The device of claim 6, wherein the transistor comprises an MOS metal oxide semiconductor field effect transistor, wherein a gate terminal of the transistor is coupled to a supply voltage higher than supply voltages supplying the input/output circuit.

8. The device of claim 4,
wherein the control circuit comprises a comparator, and
wherein a first input of the comparator is coupled to the node and a second input of the comparator is coupled to the second predefined threshold voltage.

9. The device of claim 4, wherein the control circuit comprises a Zener diode, the second predefined threshold voltage being a breakthrough voltage of the Zener diode.

10. The device of claim 4,
wherein the input/output circuit is supplied by a relatively higher positive voltage and a relatively lower positive voltage, and
wherein the second predefined threshold voltage corresponds to the relatively higher supply voltage.

11. The device of claim 1, wherein the input/output circuit is configured to at least one of receiving information carrying signals from the pad or outputting information carrying signals to the pad.

12. A device comprising:
an input/output circuit;
a pad;
a transistor coupled between the pad and the input/output signal;
a node between the transistor and the input/output circuit and a control circuit coupled to the node, coupled to a second reference voltage, and configured to:
control the transistor depending on a difference between a voltage at the node and the second reference voltage; and
reduce the voltage at the node to a first reference voltage if the voltage at the node exceeds the second reference voltage.

13. The device of claim 12, wherein the control circuit comprises a comparator.

14. The device of claim 12,
wherein the transistor comprises an NMOS transistor,
wherein a gate terminal of the NMOS transistor is coupled to a supply voltage higher than supply voltages supplying the input/output circuit, and
wherein the control circuit is configured to draw the gate terminal of the transistor towards a lower voltage if the voltage at the node exceeds the second reference voltage.

15. A method comprising:
providing a signal at an input/output pad, and
regulating a voltage at an input/output circuit coupled to the input/output pad depending on the voltage at the input/output circuit exceeding a second predetermined threshold voltage,
wherein regulating the voltage at the input/output circuit comprises reducing the voltage at the input/output circuit to a first predetermined threshold voltage if the voltage at the input/output circuit exceeds the second predetermined threshold voltage.

16. The method of claim 15, wherein regulating the voltage comprises regulating the voltage using a regulation loop.

17. The method of claim 15, further comprising supplying the input/output circuit with a first supply voltage defining a first voltage domain and a second supply voltage lower than the first supply voltage defining a second voltage domain,
wherein the second predetermined threshold voltage essentially corresponds to the first supply voltage.

18. The device of claim 1,
wherein the regulation loop comprises a Zener diode,
wherein the second predefined threshold voltage corresponds to a breakthrough voltage of the Zener diode, and
wherein the regulation loop comprises:
a current measurement device configured to measure an electrical current through the Zener diode;
a transistor coupled between the pad and the input/output circuit; and
a control circuit configured to:
compare the electrical current through the Zener diode measured by the current measurement device to a threshold current; and
if the electrical current through the Zener diode measured by the current measurement device exceeds the threshold current, decrease a voltage at a gate terminal of the transistor, causing the voltage at the node to decrease.

19. The device of claim 1, wherein the first predefined threshold voltage is equal to the second predefined threshold voltage.

20. The device of claim 1, wherein the regulation loop comprises:
a transistor coupled between the pad and the input/output circuit; and
a control circuit configured to:
receive the voltage at the node at a first input of the control circuit;
receive the second predefined threshold voltage at a second input of the control circuit; and
cause a voltage at a gate terminal of the transistor to decrease if the voltage at the node exceeds the second predefined threshold voltage, causing the voltage at the node to decrease.
